(19) United States
(12) Patent Application Publication
(10) Pub. No.: US 2019/0265829 A1
(43) Pub. Date: Aug. 29, 2019

(54) TACTILE SENSATION PROVIDING APPARATUS

(71) Applicant: ALPS ALPINE CO., LTD., Tokyo (JP)

(72) Inventors: Kunio SATO, Miyagi (JP); Daisuke TAKAI, Miyagi (JP); Yuzuru KAWANA, Miyagi (JP); Katsunari SATO, Nara (JP)

(21) Appl. No.: 16/410,216

(22) Filed: May 13, 2019

Related U.S. Application Data
(63) Continuation of application No. PCT/JP2017/042058, filed on Nov. 22, 2017.

(30) Foreign Application Priority Data
Nov. 28, 2016 (JP) 2016-230444

(51) Int. Cl. G06F 3/041; G01K 7/02

(52) U.S. Cl. CPC G06F 3/0412; G01K 7/02

(57) ABSTRACT

A tactile sensation providing apparatus includes at least one thermal sensation providing element configured to provide a thermal sensation, a vibrating element configured to provide a vibration sensation by causing the at least one thermal sensation providing element to vibrate, a tactile sensation providing region that includes the at least one thermal sensation providing element and in which the thermal sensation is provided to a body part together with the vibration sensation, and a first temperature detector disposed in the tactile sensation providing region and configured to detect a temperature of the body part.

### CROSS-REFERENCE TO RELATED APPLICATIONS

This application is a continuation of International Application No. PCT/JP2017/042058 filed on Nov. 22, 2017 and designating the U.S., which claims priority to Japanese Patent Application No. 2016-230444 filed on Nov. 28, 2016. The contents of these applications are incorporated herein by reference in their entirety.

### BACKGROUND OF THE INVENTION

### 1. Field of the Invention

The disclosures herein generally relate to a tactile sensation providing apparatus that provides thermal (hot and cold) sensations together with a vibration sensation in response to contact by a body part such as an operator's finger.

### 2. Description of the Related Art

Patent Document 1 describes a tactile sensation transmitting apparatus that includes a tactile sensation providing apparatus, a Peltier element, a sensor, and a base. The tactile sensation providing device generates a vibration by using a voice coil or a piezoelectric element, the Peltier element provides a thermal sensation, and the sensor measures an operator's skin temperature. The tactile sensation providing apparatus and the sensor are directly placed on a base, and the Peltier element is placed on the tactile sensation providing apparatus. With the above configuration, both vibration and temperature effects are provided. Thus, the tactile sensation transmitting apparatus with high expressiveness is provided.

However, the tactile sensation transmitting apparatus described in Patent Document 1 is configured to have one Peltier element placed on the tactile sensation providing apparatus. With this configuration, the fineness, expressiveness, and accuracy of the tactile sensation transmitting apparatus are not sufficient to express the texture and sense of temperature of an actual object as well as the movement and deformation of the actual object when force is applied.

### RELATED-ART DOCUMENTS

### [Patent Document] Japanese Laid-Open Patent Publication No. 7-72018

### SUMMARY OF THE INVENTION

According to at least one embodiment, in order to provide a finer tactile sensation, a detailed configuration of a Peltier element, a vibrating element, and a temperature detector is described.

According to at least one embodiment, a tactile sensation providing apparatus includes at least one thermal sensation providing element configured to provide a thermal sensation, a vibrating element configured to provide a vibration sensation by causing the at least one thermal sensation providing element to vibrate, a tactile sensation providing region that includes the at least one thermal sensation providing element and in which the thermal sensation is provided to a body part together with the vibration sensation, and a first temperature detector disposed in the tactile sensation providing region and configured to detect a temperature of the body part.

Other objects and further features of the present invention will be apparent from the following detailed description when read in conjunction with the accompanying drawings.

### BRIEF DESCRIPTION OF THE DRAWINGS

FIG. 1 is a schematic side view of a tactile sensation providing apparatus according to an embodiment of the present invention;

FIG. 2 is a schematic plan view of the tactile sensation providing apparatus according to the embodiment of the present invention; and

FIG. 3 is a functional block diagram of the tactile sensation providing apparatus according to the embodiment of the present invention.

### DESCRIPTION OF THE EMBODIMENTS

According to at least one embodiment, fineness, richness in expression, and accuracy of a tactile sensation can be improved, thus allowing a finer tactile sensation to be provided.

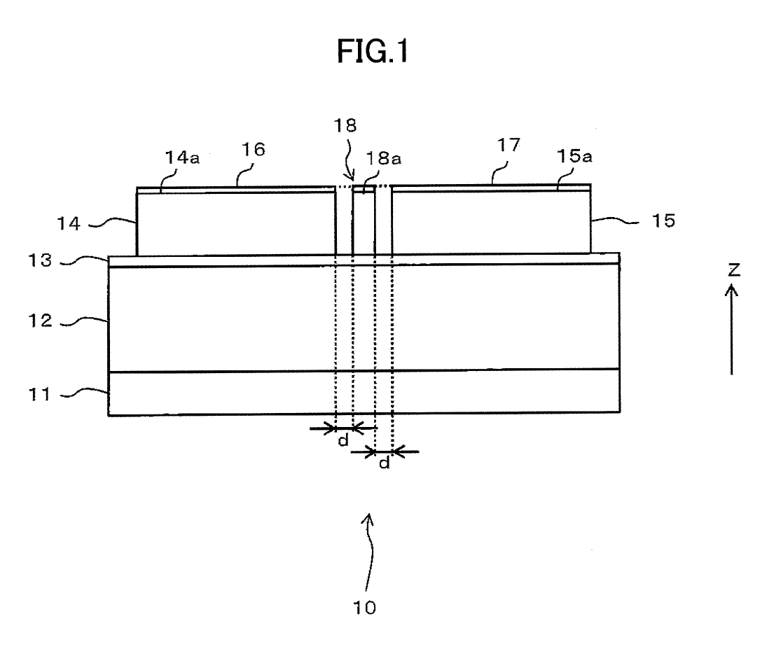

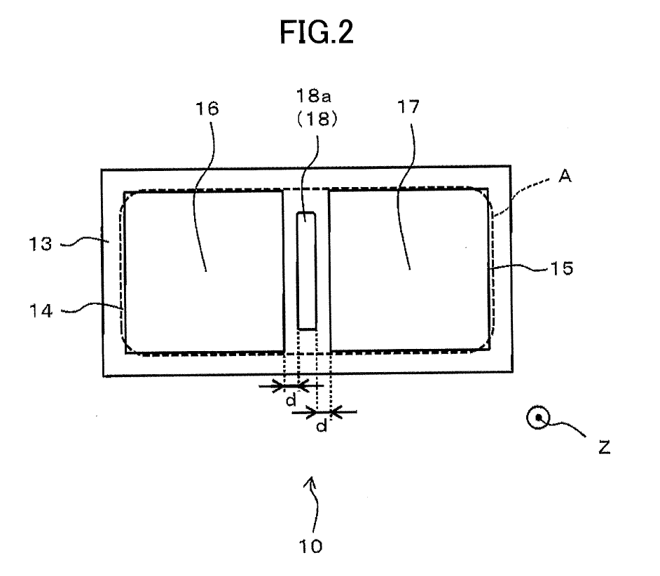

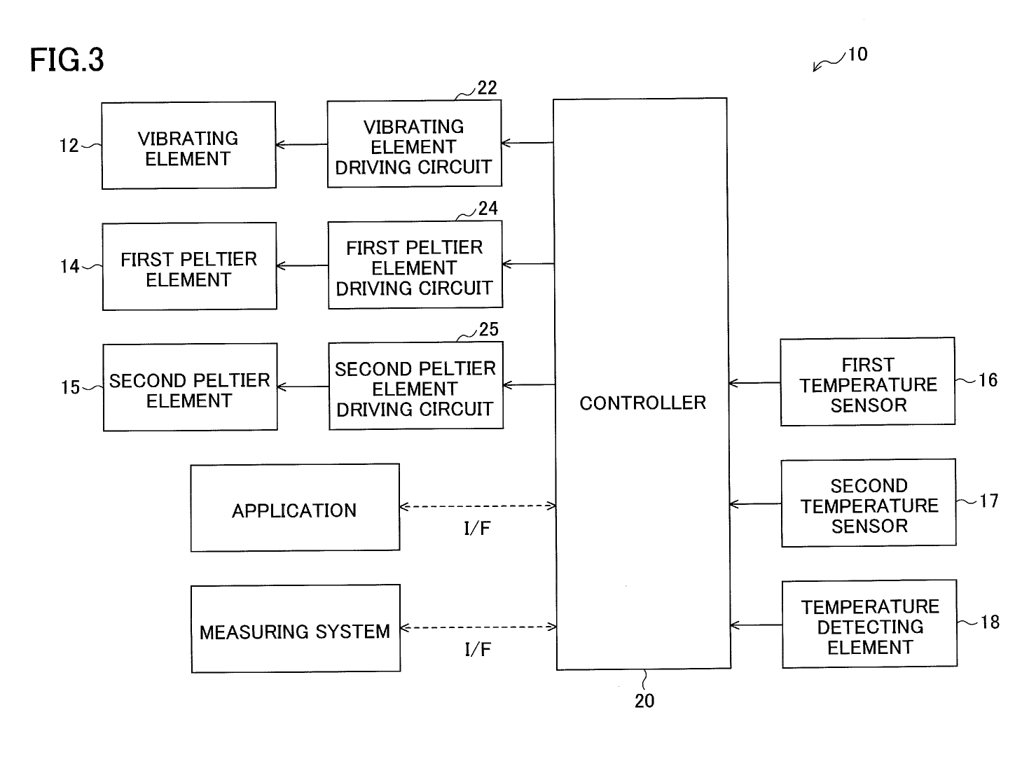

In the following, a tactile sensation providing apparatus according to an embodiment of the present invention will be described with reference to the accompanying drawings. FIG. 1 is a schematic side view of a tactile sensation providing apparatus 10 according to the embodiment. FIG. 2 is a schematic plan view of the tactile sensation providing apparatus 10. FIG. 3 is a functional block diagram of the tactile sensation providing apparatus 10. In the following direction, a state in which the tactile sensation providing apparatus 10 is viewed downward from the top in the z-direction may be referred to as a planar view.

As illustrated in FIG. 1, the tactile sensation providing apparatus 10 includes a base 11 formed of a synthetic resin material, a vibrating element 12, a transfer member 13, a first Peltier element 14, a second Peltier element 15, and a temperature detecting element 18, which functions as a first temperature detector. The vibrating element 12 is placed on the base 11, and the first Peltier element 14, the second Peltier element 15, and the temperature detecting element 18 are placed on the vibrating element 12 via the transfer member 13. It should be noted that the base 11 may be a push button provided in an operation apparatus, for example.

A first temperature sensor 16 is provided on a surface 14a of the first Peltier element 14. A second temperature sensor 17 is provided on a surface 15a of the second Peltier element 15. The first temperature sensor 16 and the second temperature sensor 17 function as a second temperature detector. Further, the temperature detecting element 18 is provided between the first Peltier element 14 and the second Peltier element 15. The first Peltier element 14, the second Peltier element 15, and the temperature detecting element 18 are sized, shaped, and arranged, such that when an operator's finger touches one or both of the first Peltier element 14 and the second Peltier element 15, the finger also touches the temperature detecting element 18 at the same time.

As illustrated in FIG. 3, detection results obtained from the first temperature sensor 16, the second temperature sensor 17, and the temperature detecting element 18 are output to a controller 20. The controller 20 outputs respective control signals to a vibrating element driving circuit 22, a first Peltier element driving circuit 24, and a second Peltier element driving circuit 25.

The vibrating element 12 has a configuration in which a vibrator is supported such that the vibrator can be freely vibrated in the top-bottom direction, namely in the z-direction illustrated in FIG. 1, by an elastic member such as a leaf spring within a case made of metal. A coil is wound around the vibrator, and a magnet facing the coil is fixed inside the case. When the vibrating element driving circuit 22 applies an alternating current to the coil in accordance with a control signal output from the controller 20, the vibrator vibrates, thereby allowing the vibrating element 12 to provide a predetermined vibration sensation. In other words, the vibrating element 12 provides a predetermined vibration sensation as controlled by the controller 20. Further, the magnitude and the period of a vibration can be controlled by changing a control signal output from the controller 20.

Further, the vibrating element 12 may have a configuration in which the vibrator is formed of a magnet and the coil facing the vibrator is fixed inside the case. Further, the vibrating element 12 may be configured by a piezoelectric element, and may be configured to vibrate in accordance with a control signal output from the controller 20.

The transfer member 13 may be, for example, an adhesive tape. The transfer member 13 is disposed on the vibrating element 12 to cover the upper surface of the vibrating element 12. The adhesiveness of the transfer member 13 causes the transfer member 13 to be fixed on the vibrating element 12, and causes the first Peltier element 14 and the second Peltier element 15 disposed on the transfer member 13 to be fixed. The transfer member 13 bonds the vibrating element 12 and the first Peltier element 14 together, and bonds the vibrating element 12 and the second Peltier element 15 together.

The transfer member 13 functions as a heat transfer material, and transfers, to the metal case of the vibrating element 12, heat generated when thermal sensations are provided by the first Peltier element 14 and the second Peltier element 15. Further, the transfer member 13 transfers a vibration sensation provided by the vibrating element 12 to both the first Peltier element 14 and the second Peltier element 15.

As described, the transfer member 13 has adhesiveness and a vibration transmission capability. Thus, a vibration sensation provided by the vibrating element 12 can be efficiently transmitted to the surfaces of the first Peltier element 14 and the second Peltier element 15. Further, the transfer member 13 has heat conductivity. Thus, the transfer member 13 can diffuse heat generated in the first Peltier element 14 and the second Peltier element 15, while also efficiently conducting heat from the bottom surface to the vibrating element 12, particularly to the metal case. In this manner, by using the metal case as a heat sink, the efficiency of heat dissipation can be improved.

The first Peltier element 14 and the second Peltier element 15 are each disposed on the transfer member 13. For example, the Peltier elements utilize Peltier effects to transfer heat when a direct current is applied from the controller 20 to a junction of two metal plates facing each other in the z-direction. In accordance with the direction and the amount of the direct current, the amount of heat flowing through the surfaces of the two metal plates change. By controlling the direction and the amount of an applied current, it is possible for an operator's finger touching the first Peltier element 14 or the second Peltier element 15 to feel a warm temperature or a cold temperature. Namely, a thermal (hot or cold) sensation can be provided.

The first Peltier element 14 and the second Peltier element 15 are arranged on the transfer member 13 while being spaced apart from each other. Accordingly, thermal sensations provided by adjacent Peltier elements are not readily affected by each other, allowing thermal sensations to be efficiently provided. In order to further reduce influences of thermal sensations provided by an adjacent Peltier element, it is desirable to provide a thermal insulator between the first Peltier element 14 and the second Peltier element 15.

One of first Peltier element 14 and the second Peltier element 15 is provided as a hot stimulator that provides a hot stimulus so as to cause the operator's hand or finger (body part) to feel a warm temperature when touching the one of the Peltier elements, and the other is provided as a cold stimulator that provides a cold stimulus so as to cause the operator to feel a cold temperature. In addition, the first Peltier element 14 and the second Peltier element 15 are alternately arranged. With this configuration, a combination of temperatures (such as 20° C. and 40° C.), which do not separately cause a pain sensation, may elicit a pain sensation (thermal grill illusion). For example, when above-described hot and cold stimulators simultaneously provide hot and cold stimuli, a pain sensation may be elicited.

As illustrated in FIG. 2, in planar view, a region (layer) where the first Peltier element 14 and the second Peltier element 15 are disposed has approximately the same area and shape as the area and shape of a tactile sensation providing region A. The tactile sensation providing region A corresponds to a contact surface of the operator's finger (body part). In the present embodiment, the contact surface of the operator's finger is the pad of the operator's finger. The tactile sensation providing region A includes a contact region corresponding to a range in which the pad of the operator's finger touches the two Peltier elements 14 and 15. As illustrated in FIG. 2, the temperature detecting element 18 is disposed near both of the first Peltier element 14 and the second Peltier element 15, and is also disposed at a center portion of the tactile sensation providing region A. With the above configuration, when the operator's finger touches one of the Peltier elements 14 and 15, the finger touches the other Peltier element at the same time. In other words, the tactile sensation providing region A is set such that a contact area of the operator's finger includes the two Peltier elements 14 and 15. As described above, the region where the two Peltier elements 14 and 15 are disposed preferably has approximately the same area and shape as the area and shape of the tactile sensation providing region A. However, the tactile sensation providing region A may be wider than the region where the two Peltier elements 14 and 15 are disposed, or the region where the two Peltier elements 14 and 15 are disposed may be wider than the tactile sensation providing region A, as long as the operator's finger can touch the first Peltier element 14 and the second Peltier element 15 at the same time. Preferably, the area of each of the first Peltier element 14 and the second Peltier element 15 where the operator's finger touches is 50% or more.

As illustrated in FIG. 3, the first Peltier element 14 and the second Peltier element 15 are connected to the first Peltier element driving circuit 24 and the second Peltier element driving circuit 25, respectively, and are further connected to the controller 20. Further, temperatures of the first Peltier element 14 and the second Peltier element 15 are independently controlled. The controller 20 sends respective control signals to the first Peltier element driving circuit 24 and the second Peltier element driving circuit 25. Based on the control signals, the first Peltier element driving circuit 24 and the second Peltier element driving circuit 25 respectively send driving signals to the first Peltier element 14 and the second Peltier element 15 at the same time or at different times. The first Peltier element 14 and the second Peltier element 15 are driven in accordance with the respective driving signals. For example, the Peltier elements can provide respective thermal sensations, such that the operator feels a warm temperature when touching one of the first Peltier element 14 and the second Peltier element 15 with the finger, and at the same time, the operator feels a cold temperature when touching the other Peltier element with the finger. In addition, the first Peltier element 14 and the second Peltier element 15 may each cause the operator to feel a warm temperature when touching the surfaces, or may each cause the operator to feel a cold temperature when touching the surfaces. Further, the surfaces of the first Peltier element 14 and the second Peltier element 15 may have different temperatures. The surface 14a of the first Peltier element 14 and the surface 15a of the second Peltier element 15 form a contact region that can be touched by the operator's finger, which is the body part.

The controller 20 sends a control signal to the vibrating element 12 such that a vibration sensation is provided. Further, the controller 20 sends control signals to the first Peltier element 14 and the second Peltier element 15 such that thermal sensations are provided. As a result, tactile sensations including thermal sensations and a vibration sensation are provided through the first Peltier element 14 and the second Peltier element 15 to the operator's finger.

The first temperature sensor 16 and the second temperature sensor 17, functioning as the second temperature detector, measure surface temperatures of the first Peltier element 14 and the second Peltier element 15, respectively. The first temperature sensor 16 is formed by, for example, printing a pair of electrodes such that the entire surface 14a of the first Peltier element 14 is covered. The second temperature sensor 17 is formed by, for example, printing a pair of electrodes such that the entire surface 15a of the second Peltier element 15 is covered. The first temperature sensor 16 and the second temperature sensor 17 are formed sufficiently thin as compared to the thickness of the first Peltier element 14 and of the second Peltier element in the z-direction. Therefore, the surface temperatures of the first Peltier element 14 and the second Peltier element 15 are transmitted to the first temperature sensor 16 and the second temperature sensor 17 with little temperature change. Further, the first temperature sensor 16 and the second temperature sensor 17 are formed so as to evenly cover the entire surface of the first Peltier element 14 and the entire surface of the second Peltier element 15. Thus, the operator does not feel any discomfort. Detection results obtained from the first temperature sensor 16 and the second temperature sensor 17 are output to the controller 20.

The temperature detecting element 18 is a thermistor that has a probe 18a at the tip, and the probe 18a detects a temperature. As illustrated in FIG. 2, the temperature detecting element 18 is disposed between the first Peltier element 14 and the second Peltier element 15 in planar view. Further, as illustrated in FIG. 1, the temperature detecting element 18 extends upward from the transfer member 13, and the probe 18a at the tip is located at the same height as the surface of the first temperature sensor 16 and the surface of the second temperature sensor 17 in the z-direction. Because the thickness of the first temperature sensor 16 and of the second temperature sensor 17 is sufficiently small, it can be said that the probe 18a is located at the same height as the surface 14a of the first Peltier element 14 and the surface 15a of the second Peltier element 15. Accordingly, the operator's finger can touch the temperature detecting element 18 at the same time when touching the first Peltier element 14 and the second Peltier element 15 without the operator feeling any discomfort. Thus, the temperature detecting element 18, functioning as the first temperature detector, can detect a temperature of the operator's finger touching the temperature detecting element 18. It should be noted that the shape and the number of probes 18a may be set as desired, as long as the probes 18a are located at the same height as the surface of the first Peltier element 14 and the surface of the second Peltier element 15.

As illustrated in FIG. 2, the temperature detecting element 18 is spaced apart a fixed distance d from each of the first Peltier element 14 and the second Peltier element 15. The distance d is set such that the temperature detecting element 18 is not readily affected by thermal sensations provided by the first Peltier element 14 and the second Peltier element 15, when the temperature detecting element 18 detects a temperature of the operator's finger touching the temperature detecting element 18. In order to further reduce influences of thermal sensations provided by the adjacent Peltier elements, thermal insulators are preferably provided between the temperature detecting element 18 and the first Peltier element 14 and between the temperature detecting element 18 and the second Peltier element 15.

The degree (a threshold) to which a hot sensation and a cold sensation are perceived is affected by a skin temperature (an initial skin temperature) of the finger before hot and cold stimuli are provided by the first Peltier element 14 and the second Peltier element 15. If the initial skin temperature of the fingertip touching a Peltier element is higher, a hot sensation is more easily perceived, and the initial skin temperature is lower, a cold sensation is more easily perceived. In other words, the finger becomes more sensitive to a hot stimulus as the initial skin temperature becomes higher, and the finger becomes more sensitive to a cold stimulus as the initial skin temperature becomes lower. Accordingly, hot and cold stimuli can be clearly provided with small temperature changes, by causing the temperature detecting element 18 to accurately detect a skin temperature of the operator's finger, and based on the detection result, causing the two Peltier elements 14 and 15 to be driven such that the skin temperature increases or decreases. For example, in order to provide a hot sensation when the temperature of the operator's fingertip is 32° C., the operator feels “warm” by increasing a temperature of a Peltier element by 2° C. to 34° C. Further, when the temperature of the operator's fingertip is 35° C., the operator feels “warm” by increasing a temperature of a Peltier element only by 1° C. to 36° C. In order to provide a sensation of cold when the temperature of the operator's fingertip is 32° C., the operator feels “cold” by decreasing the temperature of the Peltier element by 1° C. to 31° C. Further, when the temperature of the operator's fingertip is 29° C., the operator feels “cold” by decreasing the temperature of the Peltier element only by 0.5° C. to 28.5° C.

Further, one Peltier element may be employed. In such a case, a temperature detecting element, functioning as a first temperature detector, is disposed within a tactile sensation providing region and near the Peltier element, and a temperature sensor, functioning as a second temperature detector is disposed on the surface of the Peltier element.

Further, three or more Peltier elements may be provided. For example, the three or more Peltier elements are arranged in a matrix form and temperatures of the respective Peltier elements are controlled. In this manner, thermal sensations can be provided with a desired temperature gradient. With the above configuration, temperature detecting elements may each be provided between two adjacent Peltier elements, or a temperature detecting element may be provided in a region surrounded by the three or more Peltier elements.

Next, an example of an operation of the tactile sensation providing apparatus 10 and provision of tactile sensations will be described.

The controller 20 generates thermal control signals for causing the first Peltier element 14 and the second Peltier element 15 to provide thermal sensations, and generates a vibration control signal for causing the vibrating element 12 to provide a vibration sensation.

The thermal control signals are generated by the controller 20 based on detection results obtained from the first temperature sensor 16, the second temperature sensor 17, and the temperature detecting element 18. For the first Peltier element 14, a thermal control signal is generated based on detection results obtained from the first temperature sensor 16 and the temperature detecting element 18. For the second Peltier element 15, a thermal control signal is generated based on a detection result obtained from the second temperature sensor 17 and the temperature detecting element 18. For example, based on a temperature of the operator's finger detected by the temperature detecting element 18, the controller 20 sets a target temperature corresponding, to a thermal sensation to be provided. For example, in order to provide the operator with a sensation of temperature increase by 3° C., the target temperature is set to a temperature increased by 3° C. from the detected temperature of the operator's finger. Next, a thermal control signal is generated based on a difference between a surface temperature of the first Peltier element 14 detected by the first temperature sensor 16 and the above-described target temperature. For example, when the target temperature is 40° C. and the surface temperature of the first Peltier element 14 is 36° C., a thermal control signal is generated such that the surface temperature of the first Peltier element 14 increases by 4° C. The same applies to the second Peltier element 15. By performing thermal control as described above, the surface temperature of a Peltier element reaches a target temperature with high accuracy and in a short period of time. Accordingly, a more realistic thermal sensation can be provided, thus allowing a finer tactile sensation to be provided. It should be noted that the controller 20 may send a thermal control signal to only one of the Peltier elements, or may send thermal control signals to both the Peltier elements.

Further, even when the finger is not in contact with the first Peltier element 14 and the second Peltier element 15, the controller 20 causes the first temperature sensor 16 and the second temperature sensor 17 to detect surface temperatures of the first Peltier element 14 and the second Peltier element 15, and based on the detection results, the controller 20 sends driving signals to the first Peltier element 14 and the second Peltier element 15, such that the surface temperatures of the first Peltier element 14 and the second Peltier element 15 can be maintained within a predetermined temperature range. By preliminarily heating the first Peltier element 14 and the second Peltier element 15 as described above, it is possible to change the surface temperatures of the first Peltier element 14 and the second Peltier element 15 to target temperatures promptly after the operator's finger touches the Peltier elements. Accordingly, thermal sensations can be provided at a higher speed.

Respective thermal control signals are sent to the first Peltier element 14 and the second Peltier element 15. As a result, the amount of heat on the surface 14a of the first Peltier element 14 and the amount of heat on the surface 15a of the second Peltier element 15 change, thereby causing the temperature felt by the operator's finger to increase or decrease. The controller 20 independently controls provision of a thermal sensation by the first Peltier element 14 and provision of a thermal sensation by the second Peltier element 15. The controller 20 may control provision of thermal sensations by the first Peltier element 14 and the second Peltier element 15 at the same time or at different times. For example, one of the first Peltier element 14 and the second Peltier element 15 may cause the operator to feel a warm temperature when touching the one of the Peltier elements with the finger, and the other may cause the operator to feel a cold temperature. Alternatively, the first Peltier element 14 and the second Peltier element 15 may cause the operator to feel the same thermal sensation. Because the first Peltier element 14 and the second Peltier element 15 can provide different thermal sensations of hot and cold, the overall thermal response speed can increase, thus resulting in an increase in a speed at which to provide thermal sensations are provided.

For example, when the temperature of the surface 14a of the first Peltier element 14 is set high, an amount of heat is transferred from the bottom surface, facing the vibrating element 12, to the surface 14a of the first Peltier element 14. When the temperature of the surface 15a of the second Peltier element 15 is set low, an amount of heat is transferred from the surface 15a to the bottom surface of the second Peltier element 15. At this time, the amount of heat transfers from the bottom surface of the second Peltier element 15 to the metal case of the vibrating element 12, and is then transferred from the metal case to the bottom surface of the first Peltier element 14. Accordingly, a temperature difference between the first Peltier element 14 and the second Peltier element 15 can be made easily. Therefore, by setting the surface of one of the first Peltier element 14 and the second Peltier element 15 at a high temperature (a hot side) and setting the surface of the other Peltier element at a low temperature (a cold side), it becomes possible to quickly change the surface temperatures of the Peltier elements and to increase a speed at which to respond to changes in temperature felt by the operator's finger.

Further, the vibration control signal is sent to the vibrating element 12, and the vibrating element 12 generates a vibration sensation in accordance with the vibration control signal. The vibration sensation is provided through the first Peltier element 14 and the second Peltier element 15 to the operator's finger. Provision of thermal sensations by the first Peltier element 14 and the second Peltier element and provision of a vibration sensation by the vibrating element 12 may be performed simultaneously or separately.

Further, as illustrated in FIG. 3, the controller 20 may be connected to an external application and an external measuring system via interfaces (I/Fs). Even when the controller 20 is connected to the application and the measuring system, it is possible to change thermal sensations provided by the first Peltier element 14 and the second Peltier element 15 and a vibration sensation provided by the vibrating element 12, in accordance with detection results obtained from the first temperature sensor 16, the second temperature sensor 17, and the temperature detecting element 18.

In the above-described embodiment, the first temperature sensor 16 and the second temperature sensor 17 are provided. However, a configuration without the above temperature sensors may be adopted. In such a configuration without the temperature sensors, the probe 18a, the surface 14a of the first Peltier element 14, and the surface 15a of the second Peltier element 15 are preferably located at the same height as each other. In such a configuration, the controller 20 generates a thermal control signal based on a detection result obtained from the temperature detecting element 18. Taking the first Peltier element 14 as an example, the controller 20 sets a target temperature corresponding to a thermal sensation to be provided, based on a temperature of the finger detected by the temperature detecting element 18. Next, the controller 20 generates a thermal control signal based on a difference between the target temperature and a temperature corresponding to the previous thermal control signal sent to the first Peltier element 14. The second Peltier element 15 is controlled in the same manner as the first Peltier element 14. Accordingly, in the above configuration, finer tactile sensations can be provided.

Various aspects of the subject-matter described herein may be set out non-exhaustively below.

A tactile sensation providing apparatus according to an embodiment of the present invention preferably may include at least one thermal sensation providing element configured to provide a thermal sensation, a vibrating element configured to provide a vibration sensation by causing the at least one thermal sensation providing element to vibrate, and a tactile sensation providing region that includes the at least one thermal sensation providing element and in which the thermal sensation is provided to a body part together with the vibration sensation. A first temperature detector configured to detect a temperature of the body part may be disposed in the tactile sensation providing region.

Accordingly, a temperature of the thermal sensation providing element can be controlled based on the temperature of the body part detected by the first temperature detector. Thus, a thermal sensation can be provided with high accuracy and at a high speed. As a result, a more realistic thermal sensation can be provided, thus allowing a finer tactile sensation to be provided.

In the tactile sensation providing apparatus according to the embodiment, the first temperature detector may be disposed at a center portion of the tactile sensation providing region.

Accordingly, the temperature of the body part can be accurately and securely detected.

In the tactile sensation providing apparatus according to the embodiment, the at least one thermal sensation providing element may be disposed near the first temperature detector.

Accordingly, the temperature of the body part can be detected by the single first temperature detector.

In the tactile sensation providing apparatus according to the embodiment, the first temperature detector may be disposed near the at least one thermal sensation providing element, and a thermal insulator that insulates heat may be disposed between the at least one thermal sensation providing element and the first temperature detector.

Accordingly, an effect of thermal noise caused by heat in the at least one thermal sensation providing element is suppressed, thus allowing the temperature of the body part to be accurately detected.

In the tactile sensation providing apparatus according to the embodiment, the first temperature detector may be a thermistor, and a probe of the thermistor may be located at a same height as the tactile sensation providing region.

Accordingly, when the operator's body part touches the at least one thermal sensation providing element, the body part can touch the first temperature detector at the same time, without the operator feeling discomfort. Accordingly, provision of tactile sensations and detection of a temperature can be smoothly performed.

The tactile sensation providing apparatus according to the embodiment may include a second temperature detector that is disposed on a surface of the at least one thermal sensation providing element included in the tactile sensation providing region, and may be configured to detect a surface temperature of the at least one thermal sensation providing element.

Accordingly, because the surface temperature of the at least one thermal sensation providing element can be detected, it becomes possible to reach a target temperature in a short period of time.

The tactile sensation providing apparatus according to the embodiment may include a controller configured to control a temperature of the at least one thermal sensation providing element based on a detection result obtained from the first temperature detector, while controlling vibration of the vibrating element. The controller may control the thermal sensation based on the detection result obtained from the first temperature detector and on a detection result obtained from the second temperature detector.

Accordingly, it becomes possible to efficiently provide a thermal sensation at high speed in accordance with the temperature of the at least one thermal sensation providing element and on the temperature of the body part.

In the tactile sensation providing apparatus according to the embodiment, the controller may control the temperature of the at least one thermal sensation providing element, such that the surface temperature of the at least one thermal sensation providing element included in the tactile sensation providing region is maintained in a predetermined range with respect to the temperature of the body part detected by the first temperature detector.

By maintaining a temperature range of the thermal sensation providing element, the time until the surface temperature of the at least one thermal sensation providing element reaches a target temperature can be shortened. Thus, it becomes possible to increase a speed at which thermal sensations are switched, thereby allowing a finer tactile sensation to be provided.

In the tactile sensation providing apparatus according to the embodiment, a transfer member may be disposed between the at least one thermal sensation providing element and the vibrating element. The transfer member may include a heat transfer material configured to transfer, to the vibrating element, heat generated when the thermal sensation is provided by the at least one thermal sensation providing element, and includes a vibration transfer material configured to transfer the vibration sensation provided by the vibrating element to the at least one thermal sensation providing element.

Accordingly, the vibration sensation provided by the vibrating element can be efficiently transmitted to the at least one thermal sensation providing element, and further, the heat generated in the at least one thermal sensation providing element can be efficiently transmitted. As a result, the efficiency of heat dissipation can be improved.

In the tactile sensation providing apparatus according to the embodiment, the transfer member preferably may have adhesiveness, and may bond the at least one thermal sensation providing element to the vibrating element.

Accordingly, a vibration sensation provided by the vibrating element can be securely transmitted to the at least one thermal sensation providing element, and heat generated in the at least one thermal sensation providing element is efficiently dissipated.

In the tactile sensation providing apparatus according to the embodiment, the vibrating element may include a metal cover, and the transfer member may bond the metal cover to the at least one thermal sensation providing element.

Accordingly, heat generated in the at least one thermal sensation providing element is efficiently dissipated.

According to at least one embodiment, the tactile sensation providing apparatus is useful in providing a finer tactile sensation.

Further, although the present invention has been described with reference to the embodiments, the present invention is not limited to the above-described embodiments. Various variations and modifications may be made without departing from the scope of the present invention.

What is claimed is:

1. A tactile sensation providing apparatus comprising:
at least one thermal sensation providing element configured to provide a thermal sensation;
a vibrating element configured to provide a vibration sensation by causing the at least one thermal sensation providing element to vibrate;
a tactile sensation providing region that includes the at least one thermal sensation providing element and in which the thermal sensation is provided to a body part together with the vibration sensation; and
a first temperature detector disposed in the tactile sensation providing region and configured to detect a temperature of the body part.

2. The tactile sensation providing apparatus according to claim 1, wherein the first temperature detector is disposed at a center portion of the tactile sensation providing region.

3. The tactile sensation providing apparatus according to claim 1, wherein the at least one thermal sensation providing element is disposed near the first temperature detector.

4. The tactile sensation providing apparatus according to claim 3, wherein the first temperature detector is disposed near the at least one thermal sensation providing element, and a thermal insulator that insulates heat is disposed between the at least one thermal sensation providing element and the first temperature detector.

5. The tactile sensation providing apparatus according to claim 3, wherein the first temperature detector is a thermistor, and a probe of the thermistor is located at a same height as the tactile sensation providing region.

6. The tactile sensation providing apparatus according to claim 1, comprising a second temperature detector disposed on a surface of the at least one thermal sensation providing element included in the tactile sensation providing region, and configured to detect a surface temperature of the at least one thermal sensation providing element.

7. The tactile sensation providing apparatus according to claim 6, comprising a controller configured to control a temperature of the at least one thermal sensation providing element based on a detection result obtained from the first temperature detector, while controlling a vibration of the vibrating element,
wherein the controller controls the thermal sensation based on the detection result obtained from the first temperature detector and on a detection result obtained from the second temperature detector.

8. The tactile sensation providing apparatus according to claim 7, wherein the controller controls the temperature of the at least one thermal sensation providing element, such that the surface temperature of the at least one thermal sensation providing element included in the tactile sensation providing region is maintained in a predetermined range with respect to the temperature of the body part detected by the first temperature detector.

9. The tactile sensation providing apparatus according to claim 1, wherein a transfer member is disposed between the at least one thermal sensation providing element and the vibrating element, and
wherein the transfer member includes a heat transfer material configured to transfer, to the vibrating element, heat generated when the thermal sensation is provided by the at least one thermal sensation providing element, and includes a vibration transfer material configured to transfer the vibration sensation provided by the vibrating element to the at least one thermal sensation providing element.

10. The tactile sensation providing apparatus according to claim 9, wherein the transfer member has adhesiveness, and bonds the at least one thermal sensation providing element to the vibrating element.

11. The tactile sensation providing apparatus according to claim 9, wherein the vibrating element includes a metal cover, and the transfer member bonds the metal cover to the at least one thermal sensation providing element.

12. The tactile sensation providing apparatus according to claim 1, wherein a plurality of thermal sensation providing elements are provided in the tactile sensation providing region, and first temperature detectors are each disposed between adjacent thermal sensation providing elements.
